(19) United States
(12) Patent Application Publication
(10) Pub. No.: US 2014/0020580 A1
(43) Pub. Date: Jan. 23, 2014

(54) PRINTING METHOD AND PRINTING APPARATUS

(71) Applicant: Sony Corporation, Tokyo (JP)

(72) Inventor: Jun Yamaguchi, Kanagawa (JP)

(21) Appl. No.: 13/939,389

(22) Filed: Jul. 11, 2013

(30) Foreign Application Priority Data
Jul. 20, 2012 (JP) 2012-161733

(51) Int. Cl. B41F 9/00

(52) U.S. Cl. CPC B41F 9/00
USPC 101/158; 101/170

(57) ABSTRACT

A printing method includes: placing an elastic member on a first stage having an opening section, and providing ink between the elastic member and an opposing member; and causing contact between the elastic member and the opposing member with the ink interposed therebetween, by moving one or more pressurizing sections along the opening section.

### BACKGROUND

The technology relates to a printing method using a flat-shaped (sheet-shaped) plate or a flat-shaped (sheet-shaped) blanket, and a printing apparatus using this printing method.

In a printing method such as letterpress printing, intaglio printing, planographic printing, and offset printing, a plate or a blanket is wound around a roll and brought into contact with a printed member on a stage by rotation of the roll. In such a method using the roll, however, it is necessary to use a roll processed with high precision, because the rotation and alignment of the roll are performed to agree with movement of the stage. Besides, it is also necessary to increase resolution of a motor driving the stage, and control the roll and the stage precisely.

Meanwhile, a method of performing printing without using a roll has been also reported. For example, Japanese Unexamined Patent Application Publication No. 2010-158799 discloses a method in which a flat-shaped blanket is placed on a lower stage having an opening section in a central part thereof, and the circumference of the blanked is fixed. In this method, the entire blanket is pushed out by a blast of compressed air through the opening section, so that ink on the blanket is transferred to a relief plate.

### SUMMARY

In such a printing method, however, a certain period of time is necessary to push out the blanket, in order to prevent a pattern defect due to trapped air bubbles and the like.

It is desirable to provide a printing method capable of achieving transfer in a short time while preventing a pattern defect, and a printing apparatus using this method.

According to an embodiment of the technology, there is provided a printing method, including: placing an elastic member on a first stage having an opening section, and providing ink between the elastic member and an opposing member; and causing contact between the elastic member and the opposing member with the ink interposed therebetween, by moving one or more pressurizing sections along the opening section.

According to an embodiment of the technology, there is provided a printing apparatus, including: a first stage having an opening section and supporting an elastic member; a coating section providing ink between the elastic member and an opposing member; and a pressurizing section configured to apply pressure to the elastic member through the opening section.

In the printing method and the printing apparatus according to the above-described embodiments of the technology, the elastic member placed on the first stage having the opening section is pressurized from a back face thereof by the one or more pressurizing sections. The elastic member is pressurized sequentially in a moving direction of the one or more pressurizing sections by moving the one or more pressurizing sections in an in-plane direction, so that transfer of the ink proceeds while suppressing entrance of air bubbles between a transferred surface and the ink.

According to the printing method and the printing apparatus in the above-described embodiments of the technology, the contact between the elastic member and the opposing member is caused by pressurizing the elastic member from the opening section provided in the first stage through use of the one or more pressurizing sections. The one or more pressurizing sections is caused to apply pressure while being moved. Thus, entrance of air bubbles between the transferred surface and the ink is suppressed. Therefore, it is possible to achieve printing in a short time while preventing a pattern defect.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to describe the principles of the technology.

FIG. 1 is a diagram illustrating a configuration of a printing apparatus according to an embodiment of the technology.

FIG. 2 is a plan view illustrating a first stage depicted in FIG. 1.

FIG. 3A is a plan view illustrating a modification example 1 of the first stage depicted FIG. 2.

FIG. 3B is a plan view illustrating a modification example 2 of the first stage depicted in FIG. 2.

FIG. 3C is a plan view illustrating a modification example 3 of the first stage depicted in FIG. 2.

FIG. 4A is a cross-sectional diagram illustrating the first stage depicted in FIG. 3A.

FIG. 4B is a cross-sectional diagram illustrating a modification example of the first stage depicted in FIG. 3A.

FIG. 5 is a schematic diagram used to describe a pressurizing process in the first stage depicted in FIG. 4B.

FIG. 6A is a plan view illustrating a pressurizing direction in the printing apparatus depicted in FIG. 1.

FIG. 6B is a plan view illustrating a modification example 1 of the pressurizing direction depicted in FIG. 6A.

FIG. 6C is a plan view illustrating a modification example 2 of the pressurizing direction depicted in FIG. 6A.

FIG. 7A is a cross-sectional diagram illustrating a printing process performed by the printing apparatus depicted in FIG. 1.

FIG. 7B is a cross-sectional diagram illustrating a process following that illustrated in FIG. 7A.

FIG. 7C is a cross-sectional diagram illustrating a process following that illustrated in FIG. 7B.

FIG. 8A is a cross-sectional diagram illustrating a process following that illustrated in FIG. 7C.

FIG. 8B is a cross-sectional diagram illustrating a process following that illustrated in FIG. 8A.

FIG. 8C is a cross-sectional diagram illustrating a process following that illustrated in FIG. 8B.

FIG. 9 is a cross-sectional diagram illustrating a configuration of a printing apparatus according to a comparative example.

FIG. 10A is a cross-sectional diagram illustrating a printing method according to a modification 1.

FIG. 10B is a cross-sectional diagram illustrating a process following that illustrated in FIG. 10A.

FIG. 10C is a cross-sectional diagram illustrating a process following that illustrated in FIG. 10B.

FIG. 11A is a cross-sectional diagram illustrating a process following that illustrated in FIG. 10C.

FIG. 11B is a cross-sectional diagram illustrating a process following that illustrated in FIG. 11A.

FIG. 11C is a cross-sectional diagram illustrating a process following that illustrated in FIG. 11B.

FIG. 12A is a cross-sectional diagram illustrating a printing method according to a modification 2.

FIG. 12B is a cross-sectional diagram illustrating a process following that illustrated in FIG. 12A.

FIG. 12C is a cross-sectional diagram illustrating a process following that illustrated in FIG. 12B.

FIG. 13 is a cross-sectional diagram illustrating a configuration of a display unit manufactured using the printing apparatus depicted in FIG. 1.

FIG. 14 is a diagram illustrating an overall configuration of the display unit depicted in FIG. 13.

FIG. 15 is a circuit diagram illustrating an example of a pixel driving circuit depicted in FIG. 14.

FIG. 16 is a perspective diagram illustrating an appearance of an application example 1.

FIG. 17A is a perspective diagram illustrating an appearance of an application example 2 when viewed from front.

FIG. 17B is a perspective diagram illustrating an appearance of the application example 2 when viewed from back.

FIG. 18 is a perspective diagram illustrating an appearance of an application example 3.

FIG. 19 is a perspective diagram illustrating an appearance of an application example 4.

FIG. 20A is a diagram illustrating a closed state of an application example 5.

FIG. 20B is a diagram illustrating an open state of the application example 5.

### DETAILED DESCRIPTION

An embodiment of the technology will be described in detail with reference to the drawings. It is to be noted that the description will be provided in the following order.

1. Embodiment (a printing apparatus having an opening section in a first stage: an example of gravure offset printing)
2. Modification 1 (an example of reverse offset printing)
3. Modification 2 (an example of letterpress printing)
4. Application examples (display units)

### Embodiment

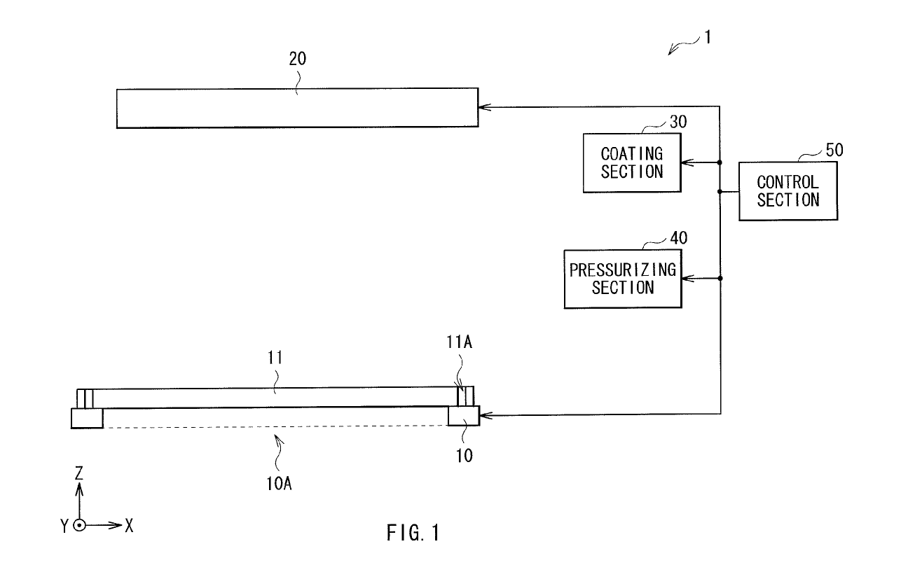

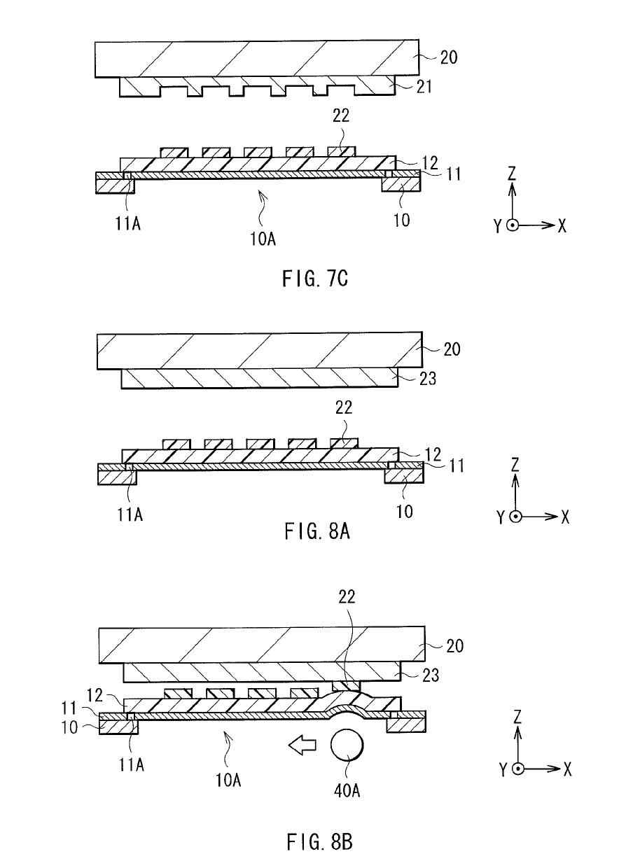

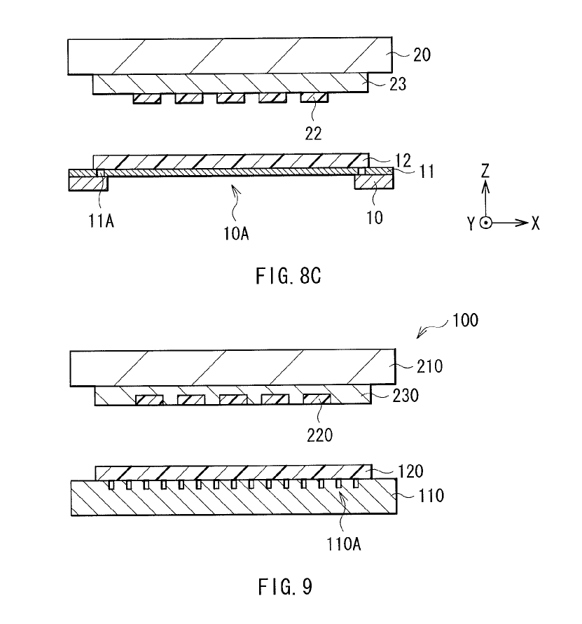

FIG. 1 schematically illustrates a configuration of a printing apparatus (a printing apparatus 1) according to an embodiment of the technology. The printing apparatus 1 includes a first stage 10 having an opening section 10A, a second stage 20 facing the first stage 10, a coating section 30, a pressurizing section 40, and a control section 50. In the printing apparatus 1, a flat-shaped elastic member (a blanket 12 in FIG. 7A, which will be described later) and an opposing member (an intaglio plate 21 in FIG. 7A or a substrate 23 in FIG. 8A, both will be described later) are provided in the first stage 10 and the second stage 20, respectively, so that printing is performed. Ink (ink 22 in FIG. 7A, which will be described later) is applied between the elastic member and the opposing member, i.e., to a surface (or a counter surface) of either of these members, by the coating section 30. In the present embodiment, the elastic member is pressurized (using a blast of compressed air, for example) by the pressurizing section 40 from a back-face side of the first stage 10, to cause contact between the opposing member and the elastic member with the ink interposed therebetween, so that the printing is performed. The control section 50 transmits signals to the first stage 10, the second stage 20, the coating section 30, and the pressurizing section 40, thereby controlling operation of these elements.

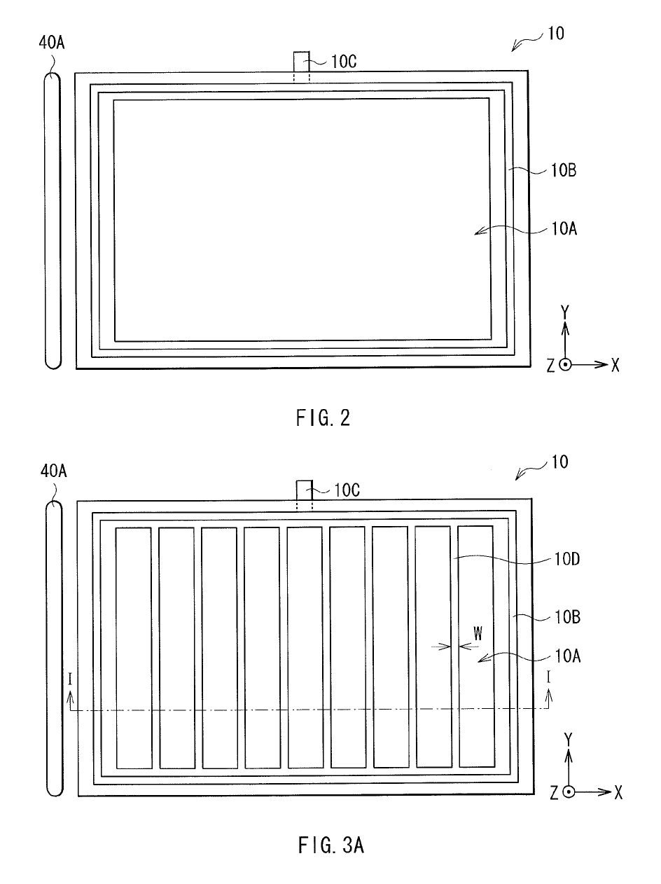

The first stage 10 may be, for example, a rectangular flat-shaped member, and have a so-called frame shape provided with the opening section 10A in a center thereof, as illustrated in FIG. 2. In the present embodiment, a uniform in-plane pressure is applied to the elastic member and the ink by the pressurizing section 40 (here, a nozzle 40A), by removing a part of the first stage 10 where the elastic member is provided. This makes it possible to perform the printing in a short time with high positional accuracy, as will be described later in detail. The circumference of the opening section 10A, namely a frame part, is provided with a fixing section 10B surrounding the opening section 10A. This fixing section 10B may be, for example, a groove. Forming a negative pressure in the groove after placing the elastic member on the first stage 10 makes it possible to prevent misalignment of the elastic member. It is to be noted that a suction port 10C used to form the negative pressure in the groove may be provided on a side face of the first stage 10. The first stage 10 may be configured using, for example, aluminum (Al) which may have a thickness (in a Z direction) of about 10 mm to about 500 mm.

The opening section 10A may be, for example, rectangular as illustrated in FIG. 2. For example, in a case in which a display unit is formed, the opening section 10A may have such a size that at least an area (e.g. a display region) where printing is necessary is arranged within the opening section 10A. Specifically, as illustrated in FIGS. 7A to 7C, the opening section 10A has a size that at least includes a whole area where the ink provided on the blanket 12 is formed.

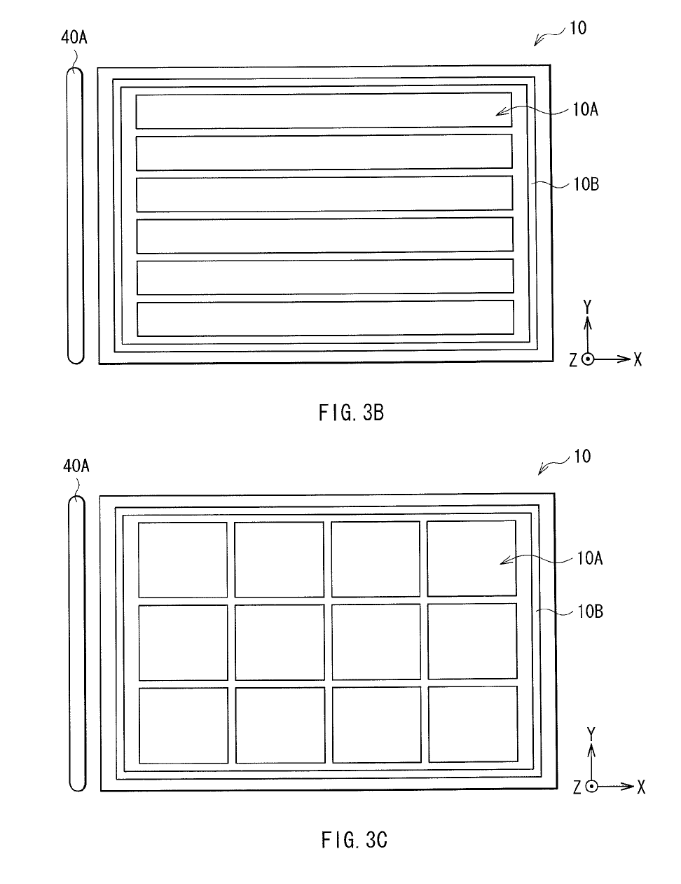

As illustrated in FIG. 3A, for example, the opening section 10A may be provided with a reinforcing structure 10D supporting the elastic member. This reinforcing structure 10D is integral with the first stage 10, and formed together with the formation of the opening section 10A. Here, the reinforcing structure 10D has a pattern in which the opening section 10A is divided in a column direction (a Y direction). Alternatively, the reinforcing structure 10D may have a pattern in which the opening section 10A is divided in a row direction (an X direction) as illustrated in FIG. 3B, for example. Still alternatively, the reinforcing structure 10D may have a pattern in which the opening section 10A is divided in a grid so that the reinforcing structure 10D is arranged in a peripheral region of a display panel as illustrated in FIG. 3C, for example. When the reinforcing structure 10D is thus formed in the grid, specifically, the reinforcing structure 10D may be preferably provided to match with chamfering of the display panel. It is only necessary for the reinforcing structure 10D to have a width (W) that allows the elastic member to be supported as described above, while preventing the pressurization by the nozzle 40A from being disturbed. Otherwise, the width of the reinforcing structure 10D is not limited in particular.

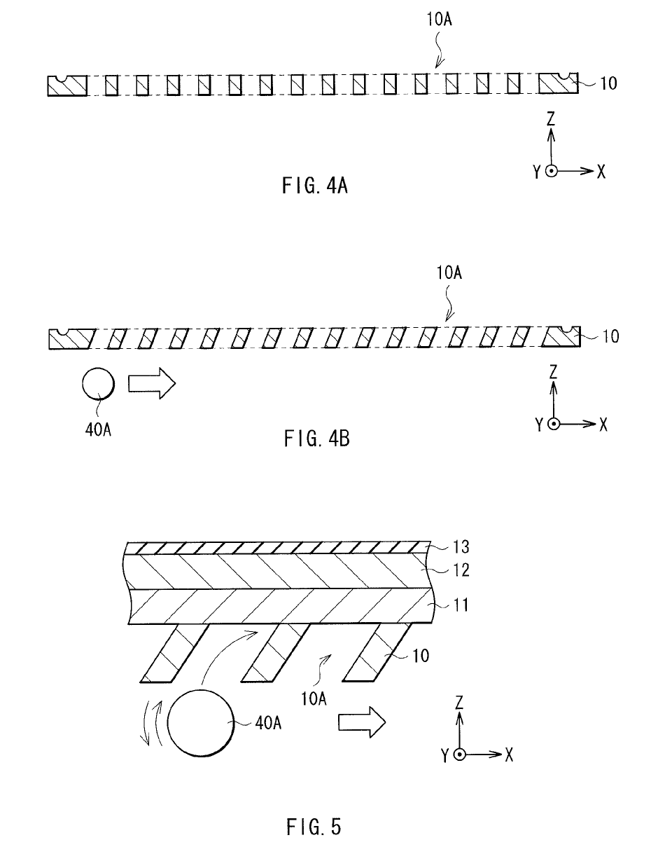

Further, an opening direction of the opening section 10A and the reinforcing structure 10D is not limited in particular, and may be a vertical direction perpendicular to a plane direction (an XY direction) of the first stage 10, namely, a thickness direction (the Z direction), as illustrated in FIG. 4A, for example. However, in particular, when the reinforcing structure 10D is provided in a direction intersecting a scanning direction (here, the X direction) of the nozzle 40A (e.g. FIG. 3A and FIG. 3C), an opening may be provided to incline toward the scanning direction (the X direction) of the nozzle 40A, as illustrated in FIG. 4B. In the case of providing the opening in the vertical direction as illustrated in FIG. 4A, the compressed air, discharged from the nozzle 40A at a position near the front of the reinforcing structure 10D, may hit a side face of the reinforcing structure 10D and may hardly reach the elastic member disposed immediately above the reinforcing structure 10D. This is likely to cause pressurization irregularity. In contrast, when the opening direction is in a state of being inclined toward the scanning direction of the nozzle 40A as illustrated in FIG. 4B, the compressed air discharged from the nozzle 40A hits the elastic member disposed immediately above the reinforcing structure 10D, by going around upon striking a side face of the reinforcing structure 10D, as illustrated in FIG. 5. In other words, it is possible to pressurize the elastic member uniformly.

On the first stage 10, a supporting member 11 is provided (FIG. 1). For example, the supporting member 11 may be connected to a frame (not illustrated) of the printing apparatus 1, and secured at a predetermined position in the printing apparatus 1. The supporting member 11 supports the elastic member, and the position of the elastic member relative to the opposing member is fixed by the supporting member 11. In the supporting member 11, a through-hole 11A used to fix the position of the elastic member is formed. The through-hole 11A may be formed, for example, at the circumference of the supporting member 11, specifically, at a position corresponding to the fixing section 10B (the groove) provided in the frame of the first stage 10. The elastic member is fixed to the supporting member 11 by this through-hole 11A, through vacuum adsorption. In other words, the first stage 10 and the elastic member are attached close each other through the through-hole 11A by vacuum adsorption, so that the respective positions are fixed. In place of the through-hole 11A, an O ring (not illustrated) or the like may be provided at the circumference of the supporting member 11 to fix the elastic member. Both the through-hole 11A and the O ring may be used to fix the elastic member. It is to be noted that the elastic member and the supporting member 11 may be fixed by adhesion using an adhesive or a chemical interaction. The supporting member 11 may be configured using, for example, a stainless steel (SUS) plate or the like which may have a thickness (in the Z direction) of about 0.05 mm to about 0.5 mm.

The second stage 20 is provided with the opposing member on a surface thereof facing the first stage 10, and supports this opposing member. The opposing member may be fixed to the second stage 20 by, for example, vacuum adsorption, electrostatic adsorption, clamping, or the like.

The coating section 30 applies the ink to the surface of either the elastic member or the opposing member. For example, the coating section 30 may have a squeegee (not illustrated), and may apply the ink by squeegee coating. In the coating section 30, other than the squeegee coating, for example, a microgravure method, a doctor blade method, spin coating, slit coating, a spraying method, a CAP coating method, a LB (Langmuir-Blodgett) film-formation method, an ink-jet method, or the like may be used.

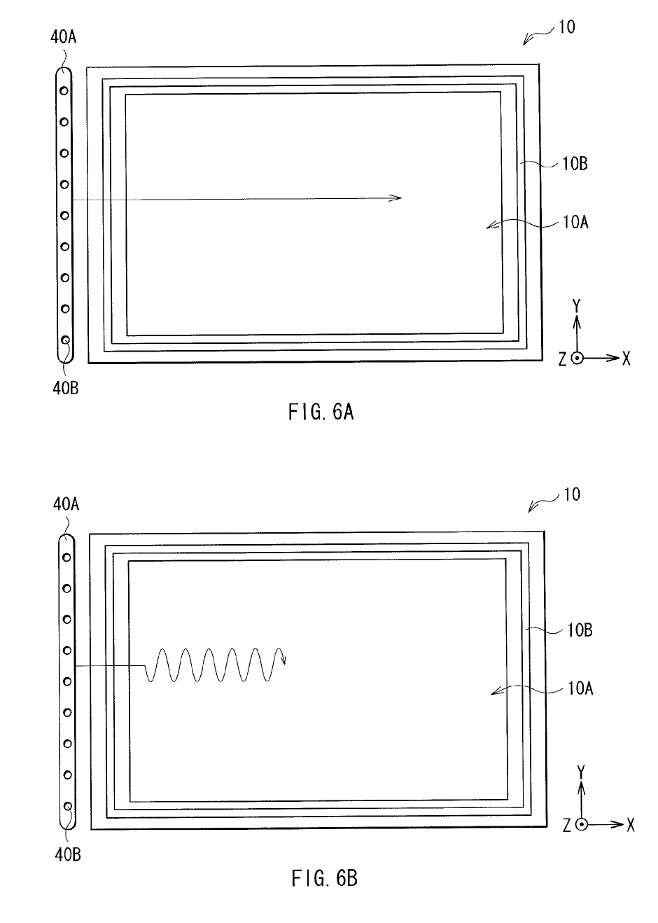

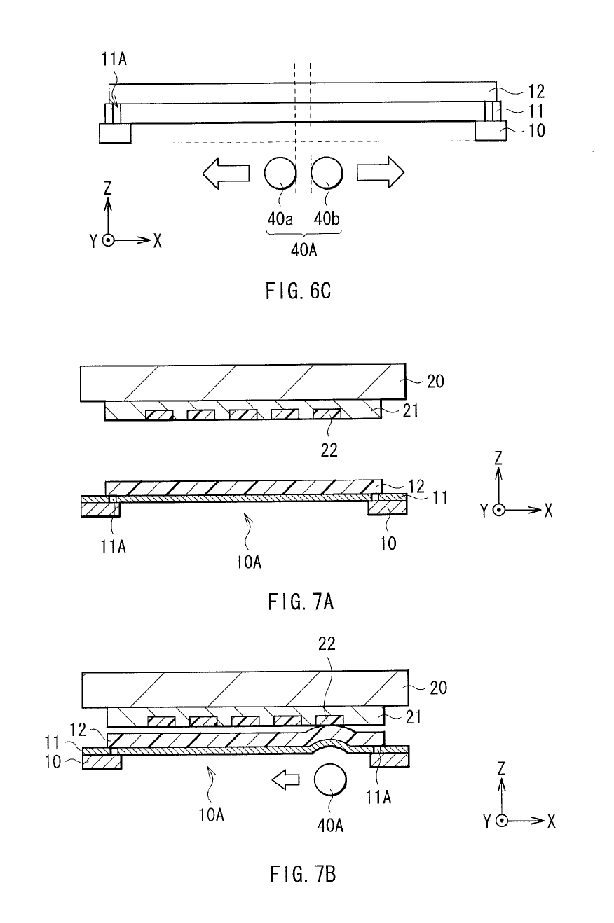

The pressurizing section 40 causes the opposing member and the elastic member to come into contact with each other, to transfer the ink. In the present embodiment, the pressurizing section 40 locally pushes up the elastic member sequentially, by pressurizing the inside of the opening from the back-face side of the first stage 10. This causes the contact between the elastic member and the opposing member with the ink interposed therebetween, so that the transfer of the ink is achieved. The pressurizing section 40 has a slit nozzle (the nozzle 40A) of about the same length as the width of one side of the opening section 10A, as illustrated in, for example, FIG. 6A. Outlets 40B are formed at predetermined spacings in the nozzle 40A. The elastic member is pressurized by the compressed air or the like discharged from the outlets 40B, thereby being pushed out in a facing direction (the Z direction). It is to be noted that the length of the nozzle 40A may be preferably about the same length as the width of the first stage 10 at one end thereof (e.g. one side parallel with the Y direction), i.e. at least longer than the one end of the opening section 10A, but is not limited in particular. For example, when the nozzle 40A is moved in the X direction while being caused to meander in an extending direction (the Y direction) of the nozzle 40A as illustrated in FIG. 6B described later, the length of the nozzle 40A may be shorter than the width of the opening section 10A.

The nozzle 40A may perform scanning linearly (here, in the X direction) from one end of the first stage 10 to the other end thereof facing the one end, as illustrated in FIG. 6A, for example. Alternatively, as mentioned above, for example, the scanning may run in the X direction while meandering by swaying in the Y direction of the nozzle 40A within the opening section 10A (FIG. 6B). This reduces pressurization irregularity due to variations in shape or arrangement intervals of the outlets 40B formed in the nozzle 40A, so that uniform transfer of the ink is allowed. Further, the pressurization is performed using a single nozzle in FIG. 6A and FIG. 6B, but is not limited thereto and may be performed using a plurality of nozzles. For example, as illustrated in FIG. 6C, two nozzles 40A (nozzles 40a and 40b) may be prepared to perform scanning independently from the center of the first stage 10 to both ends (in the X direction). This makes it possible to reduce pressing time, namely, ink transfer time. In addition, on a substrate provided with a plurality of panels, the pressurization may be performed independently for each of the panels.

After driving the coating section 30, the control section 50 causes the first stage 10 and the second stage 20 to come close to each other. The control section 50 then drives the pressurizing section 40 to control transfer of the ink between the elastic member and the opposing member. This transfer may be performed as follows. For example, the second stage 20 is lowered and set, by reducing the distance between the elastic member and the opposing member to, for example, about 50 μm or more to about 5,000 μm or less, preferably, about 50 μm or more to about 1,000 μm or less. Subsequently, the control section 50 locally pushes up the elastic member sequentially, by causing the pressurizing section 40 to perform scanning from one end of the opening section 10A provided in the first stage 10 to the other end thereof facing the one end. As a result, the opposing member and the elastic member come into contact with each other with the ink interposed therebetween, so that the ink is transferred.

Gravure offset printing using the above-described printing apparatus 1 may be performed as follows, for example (from FIG. 7A to FIG. 8C).

First, the intaglio plate 21 is placed on a plate bed (not illustrated), and a depression section of the intaglio plate 21 is filled with the ink 22 by the squeegee of the coating section 30. The intaglio plate 21 may be, for example, a plate-shaped member which may be made of quartz, glass, resin, or metal, and in which the depression section having a predetermined pattern is formed by photolithography, etching, or the like. The ink 22 may be, for example, resist ink for offset, and contains a solvent and a solute. The solute of the ink 22 may be selected as appropriate depending on a printed material. Examples of the solute may include metal powder, glass powder, resin, pigment, dye, powder made of a semiconductor such as silicon, an organic conductive material, an organic insulating material, an organic semiconductor material, an organic luminescent material, metal microparticles (metal nanoparticles), and a mixture of any combination of these materials. The solute disperses or dissolves the above-described solvent. Usable examples of the solute may include linear alkanes such as pentane, hexane, and heptane, cycloalkanes such as cyclopentane and cyclohexane, ethers such as ethyl methyl ether, diethyl ether, and tetrahydrofuran.

Next, this intaglio plate 21 is fixed to the second stage 20 so that the surface on which the ink 22 is provided faces the first stage 10. The intaglio plate 21 may be filled with the ink 22 on the second stage 20. Of the intaglio plate 21, for example, a central part and the circumference thereof may be fixed in advance to the second stage 20 by vacuum adsorption and clamping, respectively. On the other hand, the supporting member 11 and the blanket 12 are fixed to the first stage 10 (FIG. 7A). The blanket 12 may include, for example, a PDMS (polydimethylsiloxane) layer which may have a thickness of about 1 μm to about 5,000 μm, on a hard base material. The hard base material may be made of a glass plate, a metal plate, or the like, and may have a thickness of about 10 μm to about 500 μm. The blanket 12 has elasticity. The ink 22 may be applied to contact this PDMS layer. For example, STD-700 (available from Fujikura Rubber Ltd., located in Tokyo, Japan) may be used for the blanket 12.

After the blanket 12 and the intaglio plate 21 filled with the ink 22 are provided on the first stage 10 side and the second stage 20 side, respectively, the second stage 20 may be, for example, lowered by reducing the distance between the intaglio plate 21 and the blanket 12 to, for example, about 50 μm or more and about 5,000 μm or less, preferably, about 50 μm or more and about 1,000 μm or less. Subsequently, as illustrated in FIG. 7B, the nozzle 40A that discharges a blast of compressed air is moved in the X direction (in a direction indicated by an arrow in FIG. 7B). Thus, the blanket 12 is pushed up sequentially from one end (FIG. 7B: on the right side parallel with a Y axis) to the other end (FIG. 7B: on the left side parallel with the Y axis) thereof, to contact the intaglio plate 21. At this moment, the blanket 12 is adhered and fixed to the supporting member 11, by an adhesive or a chemical interaction. Alternatively, the blanket 12 may be fixed to the supporting member 11 by vacuum adsorption through the through-hole 11A. After the passage of the nozzle 40A, the blanket 12 is separated from the intaglio plate 21, and the ink 22 is transferred from the intaglio plate 21 to the blanket 12 (FIG. 7C). Thus, the ink 22 having a predetermined pattern (the depression section of the intaglio plate 21) is provided on the blanket 12.

After the ink 22 from the intaglio plate 21 is received by the blanket 12, the ink 22 is transferred from the blanket 12 to a printed member (the substrate 23) in a similar manner. The substrate 23 may be selected as appropriate according to the ink 22 (a printed material), which may be, for example, silicon, synthetic quarts, glass, metal, resin, a resin film, or the like. The transfer of the ink 22 from the blanket 12 to the substrate 23 may be performed as follows. First, the intaglio plate 21 fixed to the second stage 20 is replaced with the substrate 23 (FIG. 8A). Subsequently, contact between the blanket 12 and the substrate 23 with the ink 22 interposed therebetween is caused by the nozzle 40A (FIG. 8B). As a result, the ink 22 from the blanket 12 is received by the substrate 23 (FIG. 8C). In the printing apparatus 1, the gravure offset printing may be thus performed onto the substrate 23.

As described above, in the printing apparatus 1, the opening section 10A is provided in the first stage 10 on which the blanket 12 is disposed, and the printing is performed by causing the nozzle 40A, which discharges a blast of compressed air from the first stage 10 side to the back face of the blanket 12, to perform the scanning in the in-plane direction. This makes it possible to suppress print irregularity due to a factor such as generation of air bubbles between the first stage 10 and the blanket 12, and also reduce printing time. This will be described below.

FIG. 9 illustrates a configuration of a printing apparatus (a printing apparatus 100) according to a comparative example. This printing apparatus 100 includes a first stage 110 having a plurality of grooves 110A, and a second stage 210 facing the first stage 110. The first stage 110 and the second stage 210 support a blanket 120 and an intaglio plate 210 (or a substrate 230 (not illustrated)), respectively. The grooves 110A are provided in an area where the blanket 120 is disposed, and misalignment of the blanket 120 is prevented by reducing the pressure in these grooves. However, the grooves 110A that adsorb the blanket 120 are provided intermittently and therefore, there is such a disadvantage that air bubbles are easily generated between the first stage 110 and the blanket 120. It may be possible to suppress the generation of air bubbles by gently sucking the air in the grooves 110A. To achieve this, however, sucking for a long time is necessary, which leads to a disadvantage of a reduction in producibility.

In the printing apparatus 1 in the present embodiment, in contrast, the opening section 10A penetrating in the thickness direction of the first stage 10 is provided in the first stage 10, and the nozzle 40A is caused to perform the scanning on the back-face side of the blanket 12, specifically, from one end to the other end of the opening section 10A. In other words, the blanket 12 is pushed out in the facing direction by being sequentially pressurized locally to contact the opposing member (e.g. the intaglio plate 21) fixed to the second stage, so that the ink is transferred. In this way, it is possible to reduce the printing time while suppressing the generation of air bubbles, by removing a part of the first stage 10 on the back face of the blanket 12 and sequentially pressurizing the blanket 12 by, for example, a blast of compressed air.

As described above, in the present embodiment, the opening section 10A is provided in the area where the blanket 12 of the first stage 10 is disposed. Thus, generation of air bubbles is suppressed. In addition, the blanket 12 may be pressurized by a blast of air from the nozzle 40A which perform scanning in the opening section 10A. Therefore, it is possible to perform the printing in a short time, while suppressing print irregularity with high positional accuracy.

Moreover, the reinforcing structure 10D dividing the opening may be provided in the opening section 10A. Thus, a deflection of the blanket 12 is suppressed, making it possible to prevent misalignment in printing more reliably.

Further, the opening direction of the opening section 10A (in particular, the opening direction of the reinforcing structure 10D) may be inclined toward the scanning direction of the nozzle 40A. Thus, a collision of air with a wall surface of the opening section 10A (or a wall surface of the reinforcing structure 10D) is suppressed to improve uniformity of application of pressure to the blanket 12. It is to be noted that this inclination of the opening direction is more advantageous when the reinforcing structure 10D provided within the opening section 10A extends in the direction (the Y direction) orthogonal to the scanning direction (the X direction) of the nozzle 40A as illustrated in FIG. 3A.

Furthermore, the nozzle 40A may be caused not only to run in the single scanning direction but also to meander by swaying in the direction (the Y direction) orthogonal to the scanning direction (the X direction), for example, to allow pressurization irregularity due to variations in the outlets 40B formed in the nozzle 40A to be suppressed.

### [Modification 1]

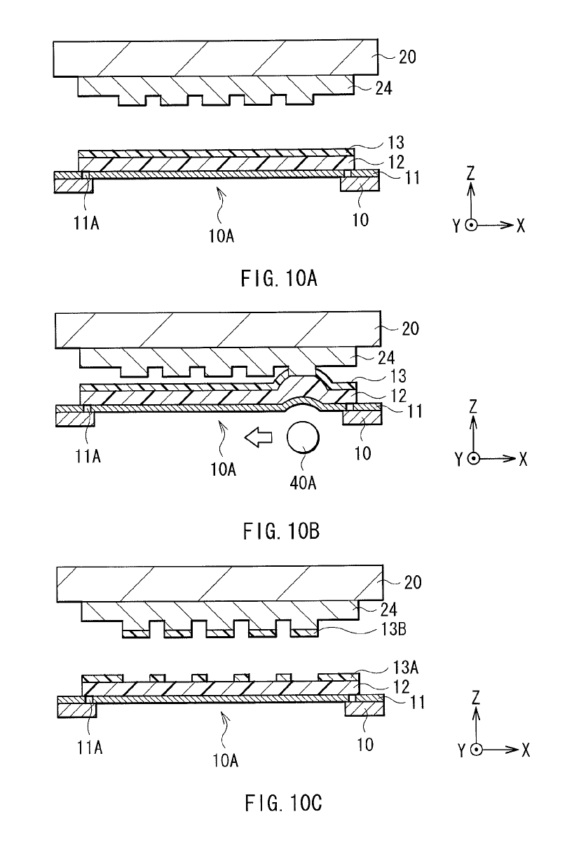

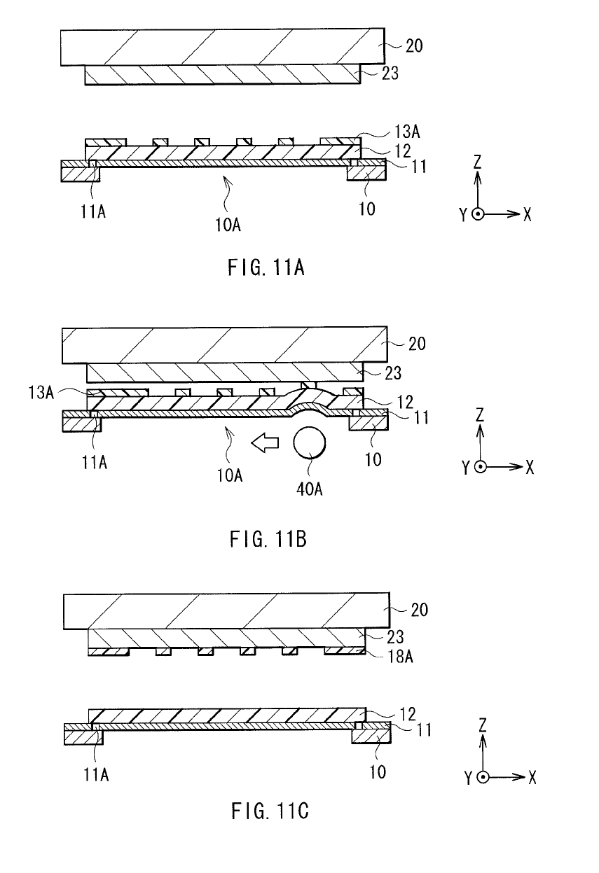

Reverse offset printing may be performed using the printing apparatus 1 of the above-described embodiment (FIG. 10A to FIG. 11C).

First, the blanket 12 is fixed onto the supporting base 14, by forming a negative pressure in the through-hole 11A provided in the supporting member 11. Subsequently, ink 13 is applied to the entire surface of the blanket 12 by the coating section 30, for example. On the other hand, a relief plate 24 is fixed to the second stage 20, so that a projection section on a surface of the relief plate 24 faces the first stage 10 (FIG. 10A).

Next, for example, the distance between the relief plate 24 and the blanket 12 may be reduced to, for example, about 50 μm or more and about 5,000 μm or less, preferably, about 50 μm or more and about 1,000 μm or less, by lowering the second stage 20. Subsequently, the nozzle 40A is caused to perform the scanning in an X direction (in a direction indicated by an arrow in FIG. 10B) as illustrated in FIG. 10B. Thus, the blanket 12 comes into contact with the relief plate 24 while being sequentially pushed up from one end to the other end thereof, by a blast of compressed air from the nozzle 40A, for example. Following the passage of the nozzle 40A, the blanket 12 is separated from the relief plate 24, so that a pattern (ink 13A) of the ink 13 is formed on the blanket 12 (FIG. 10C). This ink 13A is formed by a selective removal of the ink 13B that has made contact with the projection section of the relief plate 24, of the ink 13 applied to the blanket 12.

After the ink 13A is provided on the blanket 12, the ink 13A is transferred from the blanket 12 to the substrate 23, in a manner similar to that in the gravure offset printing described above. Specifically, after the relief plate 24 fixed to the second stage 20 is replaced with the substrate 23 (FIG. 11A), contact between the blanket 12 and the substrate 23 with the ink 13A interposed therebetween is caused by scanning of the nozzle 40A (FIG. 11B), so that the ink 13A is transferred to the substrate 23 (FIG. 11C). In the printing apparatus 1, the reverse offset printing on the substrate 23 may be thus performed.

### [Modification 2]

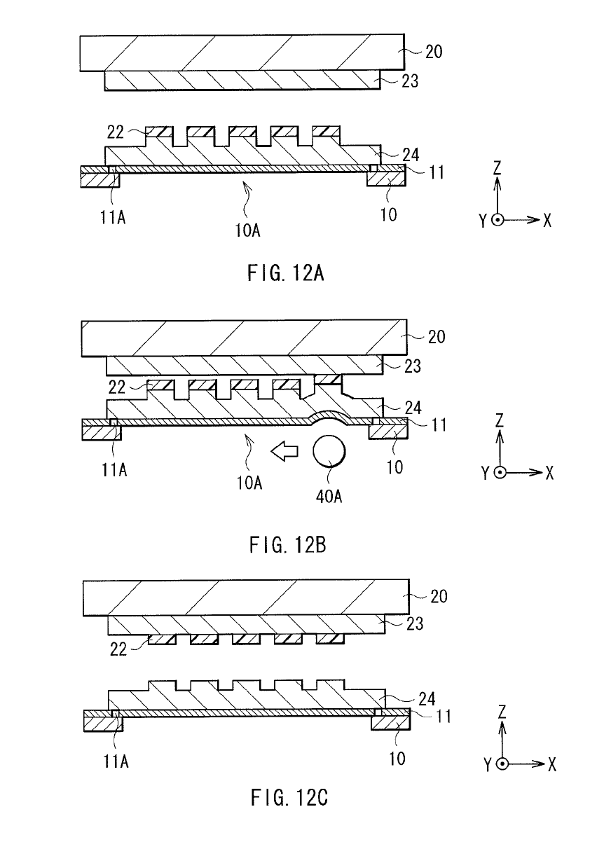

Further, letterpress printing may be performed using the printing apparatus 1 of the above-described embodiment (FIG. 12A to FIG. 12C).

First, a relief plate 24 (a plate) which may be made of, for example, an elastic material such as silicone rubber, urethane rubber, and acrylonitrile is fixed onto the first stage 10, by forming a negative pressure in the through-hole 11A provided in the supporting member 11. Subsequently, the ink 22 is provided at a projection section of the relief plate 24 by the coating section 30. To the second stage 20, on the other hand, the substrate 23 is fixed to face the relief plate 24 (FIG. 12A).

Next, for example, the distance between the substrate 23 and the relief plate 24 may be reduced to, for example, about 50 μm or more and about 5,000 μm or less, preferably, about 50 μm or more and about 1,000 μm or less, by lowering the second stage 20. Subsequently, the nozzle 40A is caused to perform the scanning in an X direction (in a direction indicated by an arrow in FIG. 12B) as illustrated in FIG. 12B. Thus, the relief plate 24 comes into contact with the substrate 23 while being sequentially pushed up from one end to the other end thereof, by a blast of compressed air from the nozzle 40A, for example. Following the passage of the nozzle 40A, the relief plate 24 is separated from the substrate 23, so that the ink 22 of the projection section is transferred to the substrate 23 (FIG. 12C). In the printing apparatus 1, the letterpress printing on the substrate 23 may be thus performed.

### Application Examples

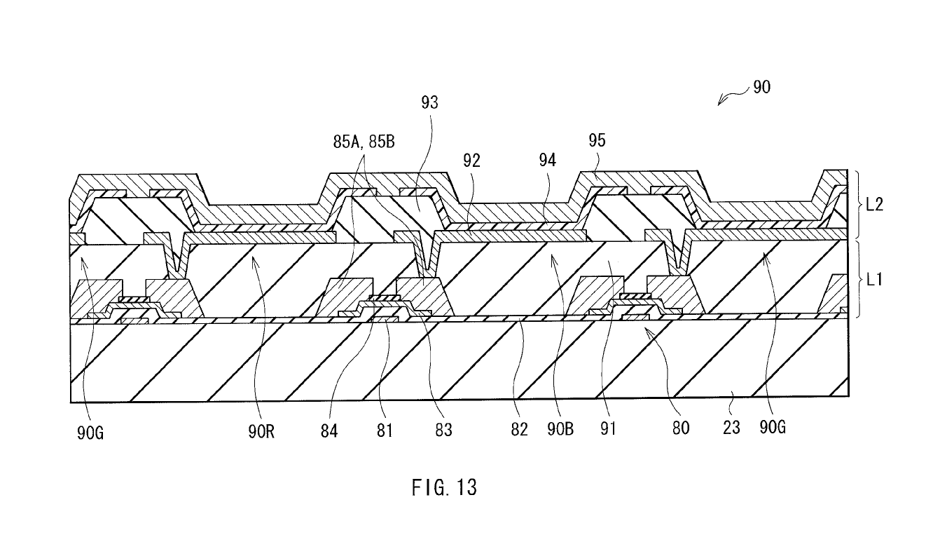

A part of a display unit (a display unit 90) illustrated in FIG. 13, for example, may be manufactured using the printing apparatus 1 of the above-described embodiment. This display unit 90 may be a self-luminous-type display unit having a plurality of organic light-emitting devices 90R, 90G, and 90B. The display unit 90 has a pixel-driving-circuit formed layer L1, a light-emission-device formed layer L2, and a counter substrate (not illustrated) in this order on the substrate 23. The light-emission-device formed layer L2 includes the organic light-emitting devices 90R, 90G, and 90B.

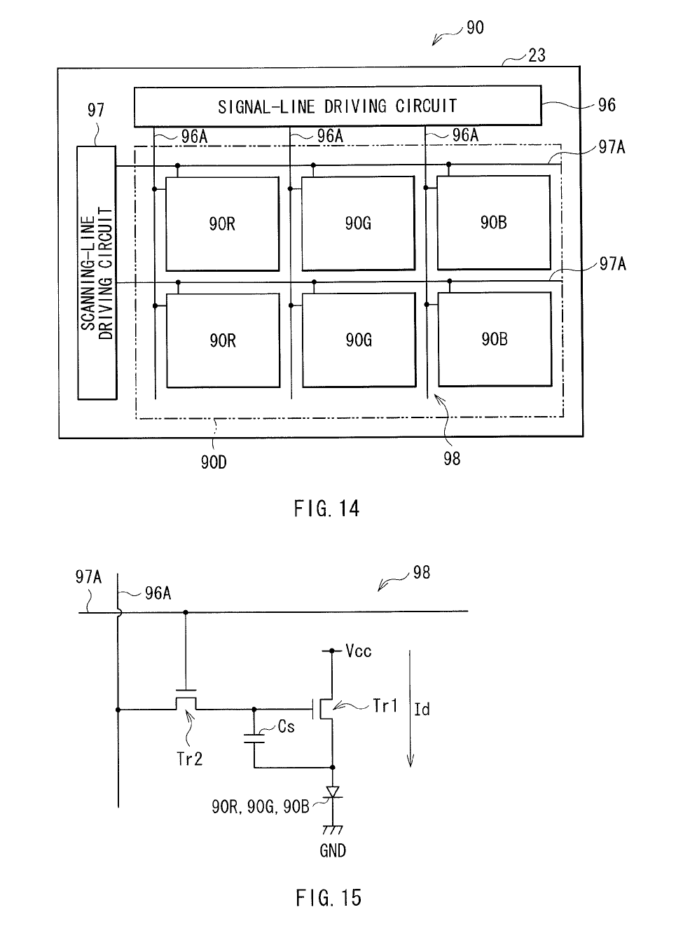

FIG. 14 illustrates an overall configuration of the display unit 90. The display unit 90 has a display region 90D on the substrate 23, and may be used as an ultrathin organic light-emitting color display device or the like. Around the display region 90D on the substrate 23, for example, a signal-line driving circuit 96 and a scanning-line driving circuit 97 which are drivers for image display may be provided.

In the display region 90D, the plurality of organic light-emitting devices 90R, 90G, and 90B arranged two-dimensionally in a matrix and a pixel driving circuit 98 used to drive these devices are formed. In the pixel driving circuit 98, a plurality of signal lines 96A are arranged in a column direction, and a plurality of scanning lines 97A are arranged in a row direction. Each of the organic light-emitting devices 90R, 90G, and 90B is provided to correspond to an intersection between each of the signal lines 96A and each of the scanning lines 97A. Each of the signal lines 96A and each of the scanning lines 97A are connected to the signal-line driving circuit 96 and the scanning-line driving circuit 97, respectively.

The signal-line driving circuit 96 supplies each of the organic light-emitting devices 90R, 90G, and 90B selected through the signal line 96A with a signal voltage of an image signal corresponding to luminance information supplied from a signal supply source (not illustrated). The signal voltage is applied from the signal-line driving circuit 96 to the signal line 96A.

The scanning-line driving circuit 97 includes a shift register etc. which sequentially perform shifting (transfer) of a start pulse in synchronization with an inputted clock pulse. When writing an image signal to the organic light-emitting devices 90R, 90G, and 90B, the scanning-line driving circuit 97 scans these devices row by row, and sequentially supplies a scanning signal to each of the scanning lines 97A. The scanning signal is supplied from the scanning-line driving circuit 97 to the scanning line 97A.

The pixel driving circuit 98 is provided in a layer level between the substrate 23 and the organic light-emitting devices 90R, 90G, and 90B, namely, the pixel-driving-circuit formed layer L1. This pixel driving circuit 98 may be an active drive circuit having a drive transistor Tr1, a write transistor Tr2, a retention capacitor Cs therebetween, and the organic light-emitting devices 90R, 90G, and 90B as illustrated in FIG. 15.

Next, a detailed configuration including elements such as the pixel-driving-circuit formed layer L1 and the light-emission-device formed layer L2 will be described with reference to FIG. 13.

A transistor 80 (the drive transistor Tr1 and the write transistor Tr2) of the pixel driving circuit 98 is formed in the pixel-driving-circuit formed layer L1, and further, the signal lines 96A and the scanning lines 97A are also embedded therein. Specifically, the transistor 80 and a flattening layer 91 are provided in this order on the substrate 23. The transistor 80 may be, for example, a bottom-gate-type transistor having a gate electrode 81, a gate insulating film 82, and a semiconductor film 83 in this order from the substrate 23 side. Source-drain electrodes 85A and 85B are electrically connected to the semiconductor film 83. A channel region of the semiconductor film 83 is covered with a channel protective film 84, and the flattening layer 91 is provided on this channel protective film 84 as well as the source-drain electrodes 85A and 85B. The flattening layer 91 is provided to flatten mainly a surface of the pixel-driving-circuit formed layer L1, and may be formed of, for example, an insulating resin material such as polyimide.

The light-emission-device formed layer L2 is provided with the organic light-emitting devices 90R, 90G, and 90B, a device separating film 93, and a sealing layer (not illustrated) used to cover them. In each of the organic light-emitting devices 90R, 90G, and 90B, a first electrode 92 serving as an anode electrode, an organic layer 94 including a luminous layer, and a second electrode 95 serving as a cathode electrode are laminated in this order from the substrate 23 side. The organic layer 94 may have, for example, a hole injection layer, a hole transport layer, the luminous layer, and an electron transport layer in this order from the first electrode 92 side. This luminous layer may be provided for each device (FIG. 15) or provided as a common to each device (not illustrated). Here, this luminous layer of the organic layer 64 may be manufactured using the printing apparatus 1. Layers other than the luminous layer may be provided as necessary. The device separating film 93 is made of an insulating material, and provided to separate the organic light-emitting devices 90R, 90G, and 90B from each other and define a light emission region of each of the organic light-emitting devices 90R, 90G, and 90B. The organic light-emitting devices 90R, 90G, and 90B are covered with a protective layer (not illustrated), and the counter substrate (not illustrated) is provided on this protective layer with an adhesive layer (not illustrated) interposed therebetween. The counter substrate may have, for example, a color filter corresponding to the organic light-emitting devices 90R, 90G, and 90B.

This display unit 90 may be manufactured as follows, for example.

First, the pixel driving circuit 98 including the transistor 80 and the flattening layer 91 are formed on the substrate 23 which may be made of glass. The pixel-driving-circuit formed layer L1 is thereby formed.

Next, a titanium film and an aluminum alloy film may be formed by, for example, sputtering, which may be then molded into a predetermined shape by, for example, a photolithographic method and dry etching, so that the first electrode 92 is formed. Subsequently, a photosensitive insulating material such as polyimide is applied onto the flattening layer 91 and the first electrode 92, and then exposure and development by photolithography are performed, so that the device separating film 93 is formed.

After the device separating film 93 is formed, the luminous layer of the organic layer 94 may be formed using the printing apparatus 1 of the above-described embodiment. The hole injection layer, the hole transport layer, and the electron transport layer of the organic layer 94 may be formed using the printing apparatus 1, or may be formed using a method such as vapor deposition. Next, the second electrode 95 may be formed on the organic layer 94 by vapor deposition, for example. The light-emission-device formed layer L2 is thereby formed.

A protective film (not illustrated) may be formed on the organic EL devices 90R, 90G, and 90B as necessary by, for example, CVD (Chemical Vapor Deposition) or sputtering. Further, the counter substrate (not illustrated) on which the color filter etc. is formed is prepared, and this counter substrate is adhered to the protective film by using the adhesive layer (not illustrated). This completes the display unit 90 illustrated in FIG. 13 to FIG. 15.

The display unit 90 as described above is applicable to display units of electronic apparatuses in all fields, which display externally-inputted image signals or internally-generated image signals as still or moving images. The electronic units may include, for example, television receivers, digital cameras, laptop computers, portable terminals such as portable telephones, video cameras, and the like.

### Application Example 1

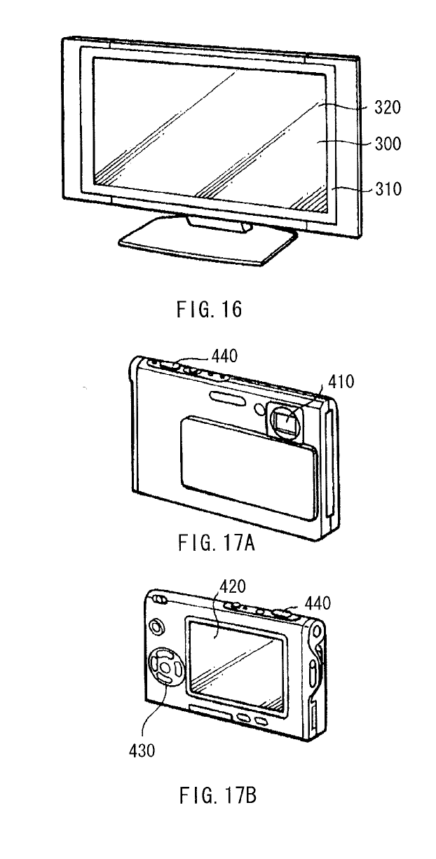

FIG. 16 illustrates an appearance of a television receiver. This television receiver may have, for example, an image-display screen section 300 that includes a front panel 310 and a filter glass 320. The image-display screen section 300 is configured using the display unit 90.

### Application Example 2

FIGS. 17A and 17B each illustrate an appearance of a digital camera. This digital camera may include, for example, a flash emitting section 410, a display section 420, a menu switch 430, and a shutter release 440. The display section 420 is configured using the display unit 90.

### Application Example 3

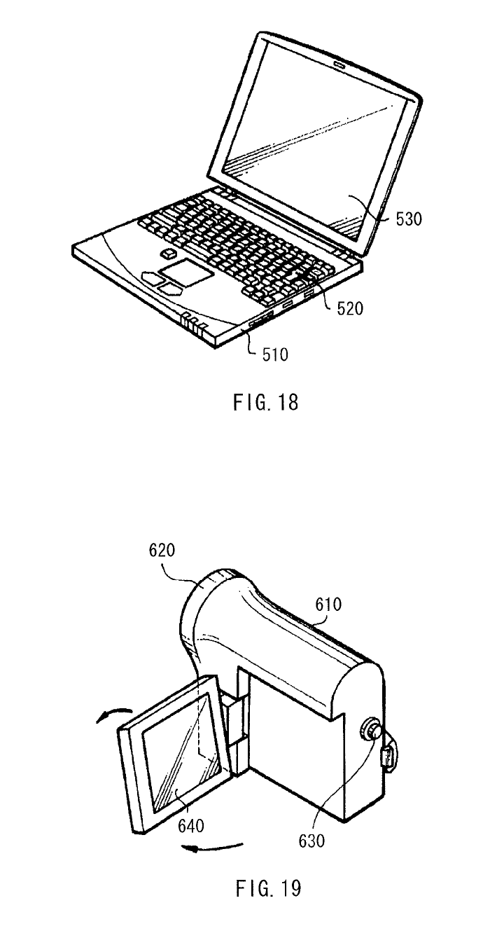

FIG. 18 illustrates an appearance of a laptop computer. This laptop computer may include, for example, a main body section 510, a keyboard 520 provided to enter characters and the like, and a display section 530 displaying an image. The display section 530 is configured using the display unit 90.

### Application Example 4

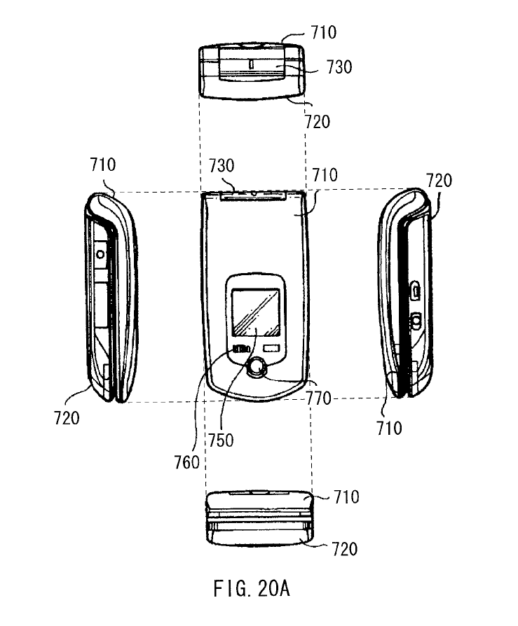

FIG. 19 illustrates an appearance of a video camera. This video camera may include, for example, a main body section 610, a lens 620 disposed on a front face of this main body section 610 to shoot an image of a subject, a start/stop switch 630 used in shooting, and a display section 640. The display section 640 is configured using the display unit 90.

### Application Example 5

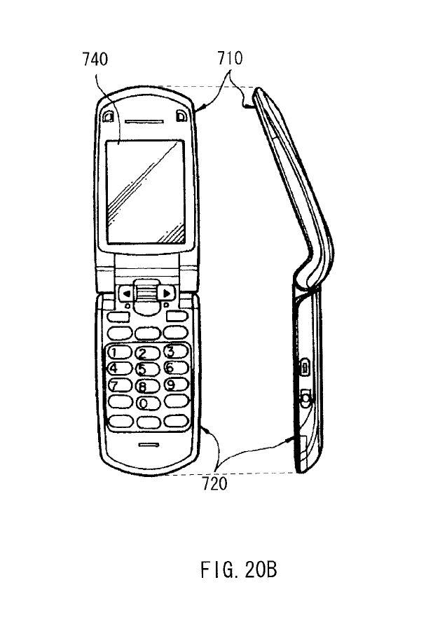

FIGS. 20A and 20B each illustrate appearances of a portable telephone. This portable telephone may be, for example, a unit in which an upper housing 710 and a lower housing 720 are connected by a coupling section (a hinge section) 730, and may include a display 740, a sub-display 750, a picture light 760, and a camera 770. The display 740 or the sub-display 750 is configured using the display unit 90.

The technology has been described with reference to the example embodiment and the modifications 1 and 2, but is not limited thereto and may be variously modified. For example, in the above-described embodiment and the like, elements such as the first stage 10 and the second stage 2 are rectangular, but are not limited thereto as long as these elements are flat-shaped. For example, a circular shape or a unique shape may be adopted.

Further, in the above-described embodiment and the like, the case in which the second stage 20 is lowered and brought closer to the first stage 10 (the supporting base 14) has been described, but the first stage 10 may be lifted. Furthermore, contact between the elastic member and the opposing member may be caused by changing the height of the protrusion 12A, without lifting and lowering of the first stage 10 and/or the second stage 20.

In addition, although the case of performing the letterpress printing by using the printing apparatus 1 has been described in the modification 2, planographic printing or intaglio printing such as gravure printing may be performed using the printing apparatus 1.

Furthermore, in the above-described application example, the case where the organic layer 94 (the luminous layer) of the display unit 90 is formed using the printing apparatus 1 has been described. However, other part of the display unit 90, e.g. the flattening layer 91 or the device separating film 93, may be formed using the printing apparatus 1. In addition, when the semiconductor film 83 of the transistor 80 is configured using an organic semiconductor material, the semiconductor film 83 may be formed using the printing apparatus 1. Alternatively, wiring (for example, the signal lines 96A and the scanning lines 97A) of the pixel driving circuit 98 may be formed through use of ink using metal nanoparticles. It is also possible to form a resist by using the printing apparatus 1.

In addition, the materials and thicknesses, or the film formation methods and film formation conditions described in the above-described embodiment and the like are illustrative and not limitative. Other materials and thicknesses, or other film formation methods and film formation conditions may be adopted.

Moreover, the printing method (the printing apparatus) of the technology is applicable to a method of manufacturing a display unit provided with any of various kinds of display devices, such as a display unit provided with any of inorganic EL (electroluminescence) devices, liquid crystal devices, electrophoretic display devices, and the like, other than a display unit with organic EL devices.

Furthermore, the technology encompasses any possible combination of some or all of the various embodiments described herein and incorporated herein.

It is possible to achieve at least the following configurations from the above-described example embodiments of the disclosure.

(1) A printing method, including:

placing an elastic member on a first stage having an opening section, and providing ink between the elastic member and an opposing member; and

causing contact between the elastic member and the opposing member with the ink interposed therebetween, by moving one or more pressurizing sections along the opening section.

(2) The printing method according to (1), wherein the opening section has a reinforcing structure inside thereof, the reinforcing structure dividing the opening section into a plurality of areas.
(3) The printing method according to (2), wherein the reinforcing structure divides the opening section in one of a row direction and a column direction.
(4) The printing method according to (2), wherein the reinforcing structure divides the opening section in a grid.
(5) The printing method according to any one of (1) to (4), wherein the opening section penetrates through the first stage.
(6) The printing method according to any one of (1) to (5), wherein the opening section extends in parallel with a thickness direction of the first stage.
(7) The printing method according to any one of (1) to (5), wherein the opening section is inclined to extend in a thickness direction of the first stage toward a direction in which the one or more pressurizing sections is moved.
(8) The printing method according to any one of (1) to (7), wherein the one or more pressurizing sections is linearly moved from a first end of the first stage to a second end of the first stage, the second end facing the first end.
(9) The printing method according to any one of (1) to (8), wherein the one or more pressurizing sections is moved from a first end of the first stage to a second end of the first stage while being meandered, the second end facing the first end.
(10) The printing method according to any one of (1) to (7), wherein each of the pressurizing sections is moved in a direction from a central part to periphery of the first stage.
(11) The printing method according to any one of (1) to (10), wherein a supporting member is provided between the first stage and the elastic member, the supporting member fixing a position of the elastic member relative to the opposing member.
(12) The printing method according to (11), wherein the elastic member and the supporting member are fixed by vacuum adsorption.
(13) The printing method according to (11), wherein the first stage, the supporting member, and the elastic member are attached to one another by vacuum adsorption.
(14) The printing method according to any one of (1) to (13), wherein the opposing member is fixed to a second stage that faces the first stage.
(15) The printing method according to any one of (1) to (14), wherein

the elastic member is a plate,

the opposing member is a printed member, and

the plate provided with the ink is brought into contact with the printed member.

(16) The printing method according to any one of (1) to (15), wherein

the elastic member is a blanket,

the opposing member is an intaglio plate, and

after a depression section of the intaglio plate is filled with the ink, the ink is transferred from the intaglio plate to the blanket.

(17) The printing method according to any one of (1) to (15), wherein

the elastic member is a blanket,

the opposing member is a relief plate, and

after the ink is applied to the blanket, the ink that has made contact with a projection section of the relief plate is selectively removed.

(18) The printing method according to any one of (1) to (15), wherein

the elastic member is a blanket,

the opposing member is a printed member, and

after the ink having a predetermined pattern is provided on the blanket, the ink is transferred from the blanket to the printed member.

(19) A printing apparatus, including:

a first stage having an opening section and supporting an elastic member;

a coating section providing ink between the elastic member and an opposing member; and

a pressurizing section configured to apply pressure to the elastic member through the opening section.

The disclosure contains subject matter related to that disclosed in Japanese Priority Patent Application JP 2012-161733 filed in the Japan Patent Office on Jul. 20, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A printing method, comprising:
placing an elastic member on a first stage having an opening section, and providing ink between the elastic member and an opposing member; and
causing contact between the elastic member and the opposing member with the ink interposed therebetween, by moving one or more pressurizing sections along the opening section.

2. The printing method according to claim 1, wherein the opening section has a reinforcing structure inside thereof, the reinforcing structure dividing the opening section into a plurality of areas.

3. The printing method according to claim 2, wherein the reinforcing structure divides the opening section in one of a row direction and a column direction.

4. The printing method according to claim 2, wherein the reinforcing structure divides the opening section in a grid.

5. The printing method according to claim 1, wherein the opening section penetrates through the first stage.

6. The printing method according to claim 1, wherein the opening section extends in parallel with a thickness direction of the first stage.

7. The printing method according to claim 1, wherein the opening section is inclined to extend in a thickness direction of the first stage toward a direction in which the one or more pressurizing sections is moved.

8. The printing method according to claim 1, wherein the one or more pressurizing sections is linearly moved from a first end of the first stage to a second end of the first stage, the second end facing the first end.

9. The printing method according to claim 1, wherein the one or more pressurizing sections is moved from a first end of the first stage to a second end of the first stage while being meandered, the second end facing the first end.

10. The printing method according to claim 1, wherein each of the pressurizing sections is moved in a direction from a central part to periphery of the first stage.

11. The printing method according to claim 1, wherein a supporting member is provided between the first stage and the elastic member, the supporting member fixing a position of the elastic member relative to the opposing member.

12. The printing method according to claim 11, wherein the elastic member and the supporting member are fixed by vacuum adsorption.

13. The printing method according to claim 11, wherein the first stage, the supporting member, and the elastic member are attached to one another by vacuum adsorption.

14. The printing method according to claim 1, wherein the opposing member is fixed to a second stage that faces the first stage.

15. The printing method according to claim 1, wherein
the elastic member is a plate,
the opposing member is a printed member, and
the plate provided with the ink is brought into contact with the printed member.

16. The printing method according to claim 1, wherein
the elastic member is a blanket,
the opposing member is an intaglio plate, and
after a depression section of the intaglio plate is filled with the ink, the ink is transferred from the intaglio plate to the blanket.

17. The printing method according to claim 1, wherein
the elastic member is a blanket,
the opposing member is a relief plate, and
after the ink is applied to the blanket, the ink that has made contact with a projection section of the relief plate is selectively removed.

18. The printing method according to claim 1, wherein
the elastic member is a blanket,
the opposing member is a printed member, and
after the ink having a predetermined pattern is provided on the blanket, the ink is transferred from the blanket to the printed member.

19. A printing apparatus, comprising:
a first stage having an opening section and supporting an elastic member;
a coating section providing ink between the elastic member and an opposing member; and
a pressurizing section configured to apply pressure to the elastic member through the opening section.
